(19) United States
(12) Patent Application Publication
(10) Pub. No.: US 2018/0339364 A1
(43) Pub. Date: Nov. 29, 2018

(54) SYSTEM AND METHOD FOR MACHINING OF RELATIVELY LARGE WORK PIECES

(71) Applicants: ACS Motion Control Ltd., Migdal HaEmek (IL); SCANLAB GmbH, Puchheim (DE)

(72) Inventors: Holger Schluter, Puchheim (DE); Ze'ev Kirshenboim, Kiryat-Tivon (IL)

(21) Appl. No.: 15/990,915

(22) Filed: May 29, 2018

Related U.S. Application Data
(60) Provisional application No. 62/512,095, filed on May 29, 2017.

(51) Int. Cl. B23K 26/082; B23K 26/08; G02B 26/10

(52) U.S. Cl. CPC B23K 26/082; B23Q 1/445; G02B 26/101; B23K 26/0876

(57) ABSTRACT

Machine for laser processing of relatively large workpieces, the processing comprising a stationary process and a scanning process comprises: a mechanical stage configured to hold the workpiece; a stage controller configured to operate the mechanical stage; a scanner configured to scan a laser beam over the workpiece; and a scanner controller configured to operate the scanner. The stage controller operates the stationary process by moving either one of the workpiece or the processing device. The scanner controller operates the scanning process by scanning a beam over the workpiece, and also moving the mechanical stage, which is done via the stage controller. The stage controller is thus enslaved to the scanner controller during the scanning process but remains independent of the scanner controller during the stationary process.

### RELATED APPLICATION

This application claims the benefit of priority under 35 USC § 119(e) of U.S. Provisional Patent Application No. 62/512,095 filed on May 29, 2017, the contents of which are incorporated herein by reference in their entirety.

### FIELD AND BACKGROUND OF THE INVENTION

The present invention, in some embodiments thereof, relates to machining of relatively large work pieces and, more particularly, but not exclusively, to machining of a work piece that requires both a stationary process and a scanned process.

In some case, laser machining of large workpieces, utilizes multiple process steps, and requires a separate system for each step. One system does one process, then the workpiece is transported to a second system, where the second process is carried out. A system for carrying out a stationary process is exemplified in FIG. 1. For example a stationary camera may be used to inspect a workpiece that traces a path past the camera. Then the workpiece is transported to a second system, as exemplified in FIG. 2, where the second process is carried out. The second process typically uses a laser beam and the laser beam is scanned over the workpiece. The scanner has a limited region over which the beam can be scanned so that the workpiece must be intermittently moved under the scanner. Some kind of a transport mechanism is required between the two different machines set up for the two systems.

The scheme of FIG. 2 is the subject of U.S. Pat. No. 8,426,768 B2 as well of applicant's copending International Patent Application No. WO2018/0142414 filed Jun. 26, 2017 and claiming a priority of Aug. 28, 2016, which carries out laser scanning. The laser scanning can be carried out while the mechanical stage moves, and a stage controller is disclosed that generates its own position commands based on a path provided by a supervisor off-line so that the stage can move during scanning. The stage controller also follows position commands provided by a supervisor in real time, and also follows position commands provided by a scanner controller so that the stage can move in synchronism with the laser scanner. The stage controller has the ability to switch between the three modes.

The stationary system, system 1, is highly accurate but relatively slow. The scanned system, system 2, is relatively fast, but less accurate and thus in many cases, both systems are needed, and the workpiece must therefore be transferred between two different machines.

### SUMMARY OF THE INVENTION

The present embodiments may provide a system and method for laser processing of large workpieces, where the entire machining consists of two or more processes, where one process is a stationary process utilizing a stationary laser beam, a camera, a pick up tool, a machining tool, an inspection tip or the like, in which the workpiece is moved on a mechanical stage. Another process utilizes a scanner for scanning a laser beam over the workpiece, where the laser beam movement relative to the workpiece is carried out by any possible combination of moving the workpiece using the stage and moving the laser beam using the scanner.

The present embodiments provide for both processes to be carried out on a single machine, so that for the stationary process the motion controller directly generates a path for the mechanical stage. In the scanning mode however the motion controller is synchronized with and becomes a slave to the scanner controller, which generates synchronized movement between the scanner and the stage as necessary or operates just the stage or just the scanner as needed.

Thus path commands are provided to the stage or motion controller during the stationary process to enable the motion controller to command the stage independently. On the other hand, the path commands are provided to the scanner controller during the scanning process, the motion controller being enslaved to the scanner controller during the scanning process.

The present embodiments may thus execute both processes utilizing a single system, thus saving significantly in equipment costs and space and leading to increased overall throughput by eliminating the need to transport the workpiece from one machine to another. There is a further saving in not needing a transportation system.

According to an aspect of some embodiments of the present invention there is provided apparatus for laser processing of relatively large workpieces, the processing comprising a stationary process and a scanning process, the apparatus comprising: a mechanical stage configured to hold the workpiece;

a stage controller configured to operate said mechanical stage;

a scanner configured to scan a laser beam over said workpiece; and

a scanner controller configured to operate said scanner;

wherein the stage controller is configured to operate the stationary process by moving the workpiece on said mechanical stage in relation to a stationary processing device, or by moving the processing device in relation to a stationary workpiece, and wherein said scanner controller is configured to operate the scanning process by scanning a beam over the workpiece, and moving said mechanical stage via said stage controller, said stage controller being enslaved to said scanner controller during the scanning process and being independent of said scanner controller during the stationary process.

In an embodiment, the scanner controller is configured to operate said scanner and said stage controller during the scanning process such that laser beam movement relative to the workpiece comprises a combination of movement of said mechanical stage and scanning of said beam, and wherein the scanner controller is configured to trigger the beam.

An embodiment may comprise a bridge to connect the stage controller and scanner to the scanner controller, the bridge being configured to obtain a first clock signal available at the scanner controller and to provide a derivation of said first clock to said stage controller, thereby to synchronize said stage controller, said scanner and said scanner controller.

In an embodiment, during the stationary process, the stage controller is configured to move the workpiece over a predetermined path, said stage controller configured to receive a pre-generated path and translate said path into a sequence of stage positions and move the stage accordingly.

In an embodiment, during the stationary process, said stage controller is configured to move the workpiece over a predetermined path, sequential stage positions of said path being provided by an external supervisor device.

In an embodiment, during the scanning process, the scanner controller is configured to receive a desired scan path from said or an external supervisor device.

In an embodiment, during the scanning process, said scanner controller is configured to using said desired scan path to generate successive positions for both said scanner and said mechanical stage.

In an embodiment, during the scanning process, the scanner controller is configured to separate a path command signal into high frequency components and low frequency components and to feed said low frequency components as a stage path command signal to said stage controller and said high frequency components as a scanner path command signal to said scanner.

In an embodiment, during the scanning process, said scanner controller is configured to use a first clock at a first clock rate and said stage controller is configured to use a second clock at a second clock rate, said second clock rate being equal or lower than said first clock rate, said stage controller being provided with a derivative of said first clock to use as said second clock.

According to a second aspect of the present invention there is provided a method for laser processing of relatively large workpieces, the processing comprising a stationary process and a scanning process, the method comprising:

holding the workpiece on a mechanical stage;

carrying out the stationary process by moving one of the workpiece on the mechanical stage in relation to a processing device, and the processing device in relation to the workpiece, under control of a stage controller;

carrying out a scanning process by scanning a beam over the workpiece while the workpiece is either stationary or moving on the mechanical stage, the scanning process comprising enslaving the stage controller to the scanner controller such that the scanner controller controls the scanning process.

According to a third aspect of the present invention there is provided apparatus for laser processing of relatively large workpieces, the processing comprising a stationary process and a scanning process, the apparatus comprising:

a mechanical stage configured to hold the workpiece;

a stage controller configured to operate said mechanical stage;

a scanner configured to scan a laser beam over said workpiece;

a scanner controller configured to operate said scanner, and

a controller,

wherein the stage controller is connected to receive path signals directly from said controller to operate the stationary process, the stationary process comprising moving the workpiece on said mechanical stage in relation to a stationary processing device, or moving the processing device in relation to a stationary workpiece, and wherein said scanner controller is connected to receive path signals directly from said controller to operate the scanning process by scanning a beam over the workpiece, and moving said mechanical stage via said stage controller, said stage controller being enslaved to said scanner controller during the scanning process and being independent of said scanner controller during the stationary process.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram showing a block diagram of a machine and associated system for carrying out a stationary operation on a workpiece according to the known art;

FIG. 2 is a simplified diagram showing a machine and associated system for carrying out a scanned operation on a workpiece according to the known art;

FIG. 3 is a simplified diagram showing a machine and associated system for carrying out both stationary and scanned operations on a workpiece according to an embodiment of the present invention; and

FIG. 4 is a simplified diagram illustrating operation of the machine and associated system of FIG. 3.

### DESCRIPTION OF SPECIFIC EMBODIMENTS OF THE INVENTION

The present invention, in some embodiments thereof, relates to machining of relatively large work pieces and, more particularly, but not exclusively, to machining of a work piece that requires both a stationary process and a scanning process. A stationary process is one in which the relative motion between the workpiece and the tool doing the process is achieved by moving only one part, either the workpiece or the tool, but not both.

In a scanned process, the relative motion between the workpiece and the tool carrying out the process may be achieved by moving both parts.

A single machine may be controlled according to the present embodiments to provide both stationary and scanning processes, so that both kinds of processes may be applied to a single workpiece without the need for two machines or for the need for transport of the workpiece between the two machines.

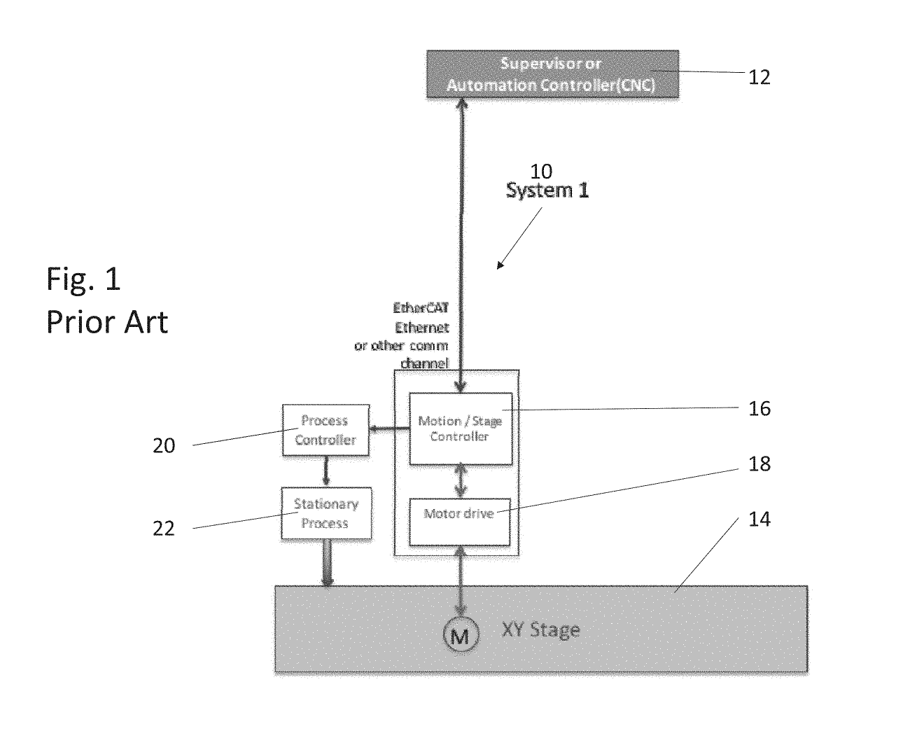

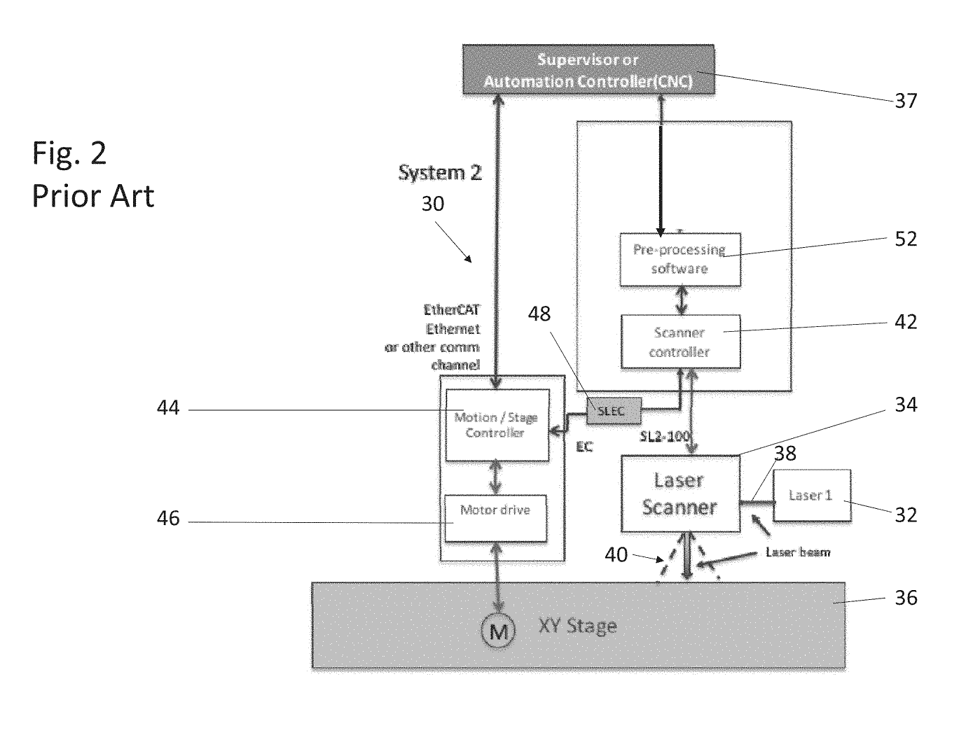

A machine and associated system according to the present embodiments thus includes the system 2 of FIG. 2 and as described in applicant's copending International Patent Application No. WO2018/0142414, with the addition of the stationary process of FIG. 1 and its associated controller through which the stage controller can manage and trigger the laser along the required path.

The resulting apparatus may carry out laser processing of relatively large workpieces using both a stationary machining process and a scanning process.

The apparatus may include a mechanical stage that holds and moves the workpiece during the process. A stage controller operates the mechanical stage. A scanner scans a laser beam over the workpiece, and a scanner controller operates the scanner. The scanner controller according to the present embodiments has an additional task of operating the stage controller, but only during the scanning process. The stage controller works independently during the stationary process.

Path commands are thus sent by the supervisor to the stage controller during the stationary process and to the scanner controller during the scanning process.

During the stationary process the stage controller moves the mechanical stage on which the workpiece is mounted in relation to a stationary processing device such as a camera, pick up tool etc. by following the path commands provided by the supervisor. During the scanning process, the scanner controller decomposes the path commands provided by the supervisor into separate path commands for the scanner and separate path commands to the stage that are transferred to the stage controller to execute them. That is to say the stage controller becomes enslaved to the scanner controller during the scanning process, but remains independent of the scanner controller during the stationary process.

Compared to the conventional two-machine system based solution, there are savings of one mechanical stage, one stage motion controller and associated drives, a transportation system and the space required to accommodate the two machines and the transportation system. The transportation system would typically be a robot, and would transport the workpiece from a first machine operating System 1 to a second machine operating System 2. In addition to savings in hardware, the process is also faster since the transport time is saved.

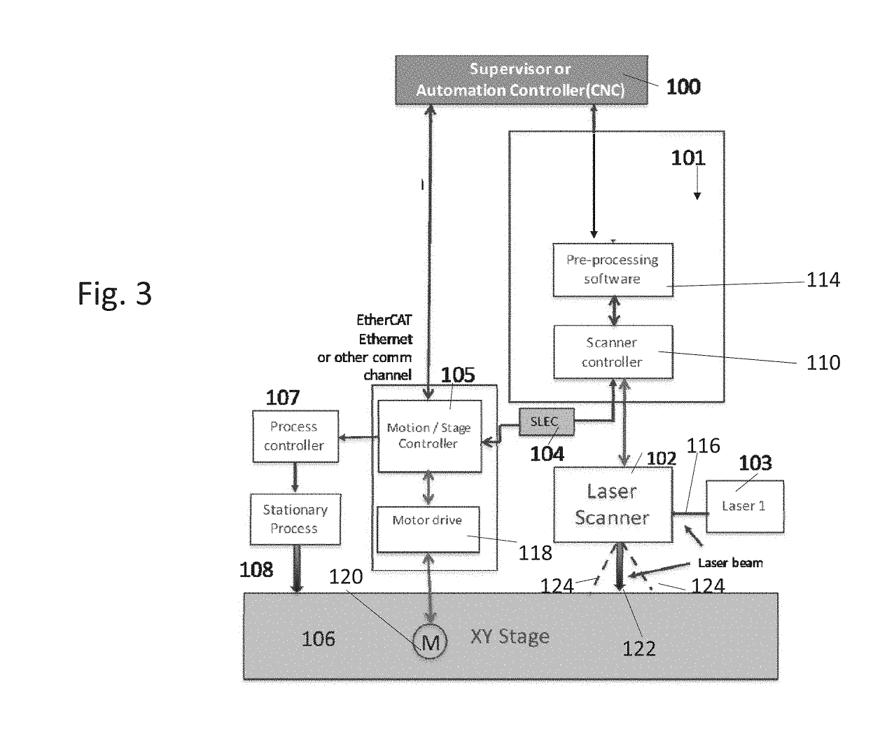

For purposes of better understanding some embodiments of the present invention, as illustrated in FIG. 3 of the drawings, reference has been made in the background to the construction and operation of a two separate machines as illustrated in FIGS. 1 and 2.

Reference is now made to FIG. 1 which is a block diagram illustrating first system 10 in which a stationary device carries out a process on a workpiece moving on a stage. For example a stationary camera may be used to inspect a workpiece that traces a path past the camera. A Supervisor or automation controller 12 operates the processing application. The supervisor may be a typical CNC controller.

More generally, a stationary process utilizes stationary devices such as a laser, a camera, a pick up tool, a machining tool, an inspection tool or some other means to apply a process to the workpiece. The stationary process may for example involve any of a camera taking photographs, a laser firing pulses, a pick up process using a pick up tool, a pick up process for picking parts, a machining process using a tool to machine a part, and an inspection process using an inspection tool to inspecting a surface or a bulk of the workpiece or a part of the workpiece.

A mechanical XY stage 14, which is large enough to fit the size of the workpiece, carries the workpiece that is to be processed.

A Motion/Stage controller 16, including one or more motor drives 18, moves the stage 14 along the required path, say as defined in a plan or drawing, and also controls and triggers the process to take place along the path. Triggering may be directly carried out or may be carried out via a dedicated controller 20 for the stationary process 22.

Accuracy of the process depends on the accuracy of the stage 14, but the stage is relatively slow, limited by the bandwidth of the stage and its associated controller 16 due to weight. An EtherCAT or Ethernet or other communication channel connects the supervisor 12 to the Motion/stage controller 16.

It is noted that instead of moving the workpiece, the stage controller may move the processing tool, the workpiece remaining stationary.

Reference is now made to FIG. 2, which illustrates a second system 30, for a second stage which utilizes a laser 32, a laser scanner 34 and a mechanical stage 36. The system consists of a computer 37 that runs the processing application and acts as a supervisor or automation controller, and may be the same as the CNC controller described in respect of FIG. 1. A laser source 32 feeds scanner 34 with a laser beam 38. Scanner 34 moves the laser beam 40 at very high speeds and accelerations over a limited area defined by its field of view and indicated by hashed lines. The accuracy achieved by the scanner may be inferior to the accuracy provided by the mechanical stage with a stationary laser as in FIG. 1.

The system further comprises a scanner controller 42, and mechanical stage 36, which is large enough to fit the size of the workpiece, carries the workpiece to be processed.

Motion/Stage controller 44 and motor drive or drives 46 to move the stage 36.

A bridge (SLEC) 48 is used to transfer information between the scanner controller 42 and the stage controller 44, including position commands that the stage controller needs to follow and clock information that is used to synchronize the scanner controller and the stage controller.

Pre-processing software 52 may be provided to carry out preliminary processing and to derive the scanner position commands and the stage position commands by decomposition of the original path command provided by the supervisor 37.

The scanned laser beam 40 is controlled and triggered along the required path or drawing by the scanner controller 42. The laser beam 40 may be moved along the required path or drawing using one of the following combinations/schemes:

1) utilizing the scanner 34 alone, controlled by scanner controller 42, to move the laser beam. The scanner may move the beam over small working areas defined by the field of view of the scanner.

2) moving the stage 36 to a desired position and then remaining still, and then utilizing the scanner 34 to move the laser beam over a limited area. Once complete, the stage 36 moves to a new point and then utilizes the scanner again and so on.

3) Simultaneously utilizing both the stage 36 and the scanner 34 to move the laser beam 40 relative to the workpiece along the required path. The scanner controller 42 may also control and trigger the laser along the path.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Reference is now made to FIG. 3, which is a block diagram illustrating a machine and system according to an embodiment of the present invention.

The same machine is able to carry out a first stationary process in which only the stage carrying the workpiece is moving and a second scanned process in which both the stage carrying the workpiece and a laser beam are moving.

The system may consist of a supervisor 100 which may be the same CNC controller used in FIGS. 1 and 2, a scanner controller system 101, including the scanner controller unit itself 110, and its associated pre-processing and more general software 114. Scanner 102 steers laser beam 116, to form steered laser beam 122, and triggers it on and off. As before the beam cannot be scanned beyond hashed lines 124.

A Laser source 103 feeds the scanner. A bridge (SLEC) 104 is used to transfer information between the scanner controller and the stage controller 104. As discussed above, the bridge may pass on a derivation of the clock at the scanner controller so as to synchronize the scanner controller with the other devices.

A stage motion controller 105 and its associated motor drive or drives 118 moves stage 106 and trigger a stationary process 108 (such as a camera or stationary laser) on and off via a process controller 107.

Mechanical stage 106 has associated motors 120.

It is noted that synchronization via the bridge is provided for the scanning process but is not needed for the stationary process, where the path signal is provided by the supervisor 100 directly to the motion controller 105 and the scanner controller is not used.

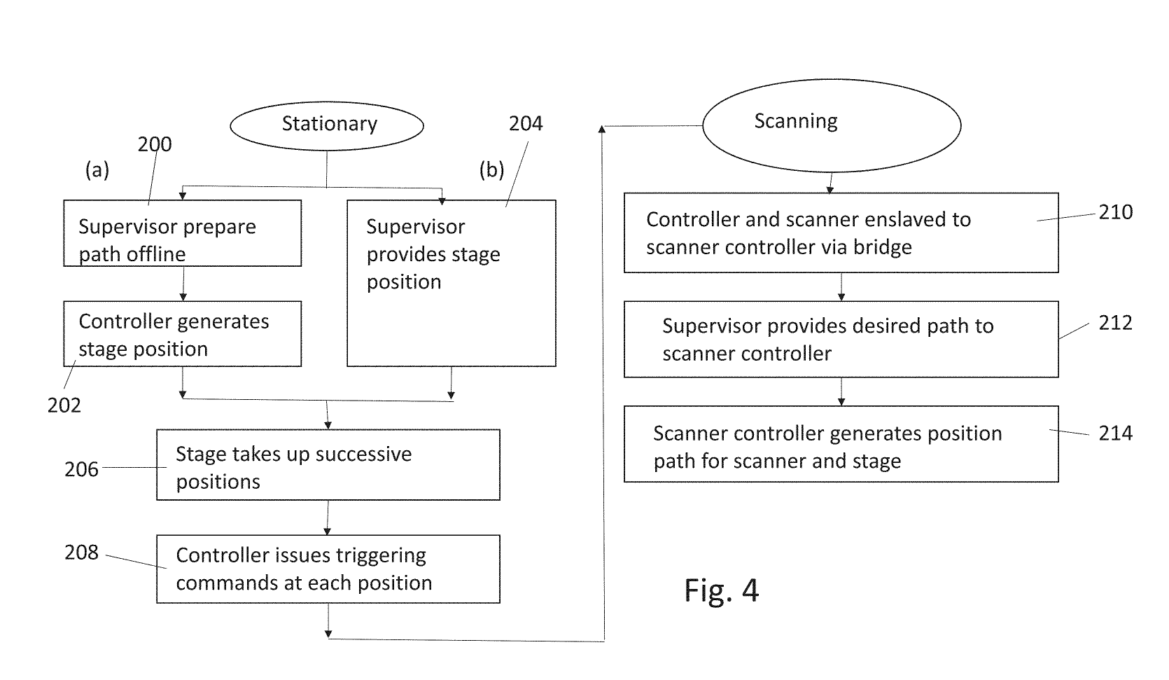

Reference is now made to FIG. 4, which is a simplified flow chart of an operation of the machine of FIG. 3 according to an embodiment of the present invention.

In FIG. 4, two separate phases of a stationary and a scanning process are shown one following the other, but a complete operation may be any combination of any number of these two phases. For example a stationary process may be followed by a scanning process and then another stationary process and then another scanning process.

The supervisor 100 instructs the motion controller 105 to execute a path and execute the process. For instance: a path may be taken over the workpiece for which one requires to obtain images or make an incision with a laser or pick up a part. The path may have desired parameters such as starting point, interval, end point etc. The supervisor 100 may follow path (a) or path (b).

In the case of path (a) the supervisor 100 feeds the controller 105 the desired path information offline—box 200—and once instructed, the controller 105 generates the instantaneous desired position—box 202—of the stage 106 for each control cycle.

In the case of path (b) the supervisor 100 itself generates the instantaneous desired position of the stage 106 in box 204 and feeds it to the controller 105 each control cycle. In the case of path (b), the supervisor 100 may actually be a CNC controller and may utilizes the stage controller 105 as a smart drive that follows its position commands.

For case (b) the CNC 100 may be synchronized with the motion controller 105.

In both cases, the controller 105 moves the stage to successive positions—206 and for each position issues process triggering pulses—box 208. The triggering pulses may be to operate the laser or trigger the camera to take a picture or to trigger a pick up command to operate a pick up tool or trigger a signal to turn a spindle for a machining tool, and may for example be sent to the laser controller 107 or to the controller of any other appropriate device.

Once the stationary process is complete, the supervisor 100 may instruct the controller 105 to enslave itself and the stage 106 to the scanner controller—box 210. This ensures that the stage controller 105 and stage 106 follow position commands received via the SLEC bridge 104. The bridge 104 also transfers clock information related to the clock used by the scanner controller 110 and the motion controller 105 synchronizes itself to the scanner controller 110 by using the same clock.

In box 212 the supervisor 100 then feeds the associated software of the scanner controller 101 with the desired path.

In box 214, the scanner controller and its associated software 101 generates the position path for the scanner 102 as well as for the stage 106. The process is as described in International Patent Application No. WO2018/0142414, and the process executes the path and lires the laser 103 along the path as needed. As an example of a way in which the stage and scanner can be used together during the scanning process, the scanner controller may decompose the incoming path command signal into high frequency components and low frequency components. The scanner controller may then feed the low frequency components as a stage path command signal to the stage controller and feed the high frequency components as a scanner path command signal to the scanner. Thus the stage makes the slower movements and the scanner provides the faster movements. The stage and scanner are synchronized as explained.

An example is based on embodiments described in International Patent Application No. WO2018/0142414 which synchronize the motion controller 105 to the scanner controller 110 by providing a derivation of the clock used by the scanner controller to the motion controller. The motion controller 105 may be a device that can be both an EtherCAT master and an EtherCAT slave The CNC controller 100 may be a device that is an EtherCAT master, and the controller 105 may be the node of an EtherCAT network based on which the distributed clock of the EtherCAT network that is managed by the supervisor 100 is generated.

It is expected that during the life of a patent maturing from this application many relevant CNC devices, scanners, scanner controllers, X-Y stages, and their motors and drivers, cameras and laser scanners, and clocked networks will be developed and the scopes of the corresponding terms are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. Apparatus for laser processing of relatively large workpieces, the processing comprising a stationary process and a scanning process, the apparatus comprising:
a mechanical stage configured to hold the workpiece;
a stage controller configured to operate said mechanical stage;
a scanner configured to scan a laser beam over said workpiece; and
a scanner controller configured to operate said scanner;
wherein the stage controller is configured to operate the stationary process by moving the workpiece on said mechanical stage in relation to a stationary processing device, or by moving the processing device in relation to a stationary workpiece, and wherein said scanner controller is configured to operate the scanning process by scanning a beam over the workpiece, and moving said mechanical stage via said stage controller, said stage controller being enslaved to said scanner controller during the scanning process and being independent of said scanner controller during the stationary process.

2. The apparatus of claim 1, wherein the scanner controller is configured to operate said scanner and said stage controller during the scanning process such that laser beam movement relative to the workpiece comprises a combination of movement of said mechanical stage and scanning of said beam, and wherein the scanner controller is configured to trigger the beam.

3. The apparatus of claim 1, comprising a bridge to connect the stage controller and scanner to the scanner controller, the bridge being configured to obtain a first clock signal available at the scanner controller and to provide a derivation of said first clock to said stage controller, thereby to synchronize said stage controller, said scanner and said scanner controller.

4. The apparatus of claim 1, wherein during the stationary process, the stage controller is configured to move the workpiece over a predetermined path, said stage controller configured to receive a pre-generated path and translate said path into a sequence of stage positions and move the stage accordingly.

5. The apparatus of claim 1, wherein during the stationary process, said stage controller is configured to move the workpiece over a predetermined path, sequential stage positions of said path being provided by an external supervisor device.

6. The apparatus of claim 1, wherein, during the scanning process, the scanner controller is configured to receive a desired scan path from said or an external supervisor device.

7. The apparatus of claim 6, wherein, during the scanning process, said scanner controller is configured to using said desired scan path to generate successive positions for both said scanner and said mechanical stage.

8. The apparatus of claim 1, wherein, during the scanning process, the scanner controller is configured to separate a path command signal into high frequency components and low frequency components and to feed said low frequency components as a stage path command signal to said stage controller and said high frequency components as a scanner path command signal to said scanner.

9. The apparatus of claim 1, wherein, during the scanning process, said scanner controller is configured to use a first clock at a first clock rate and said stage controller is configured to use a second clock at a second clock rate, said second clock rate being equal or lower than said first clock rate, said stage controller being provided with a derivative of said first clock to use as said second clock.

10. Method for laser processing of relatively large workpieces, the processing comprising a stationary process and a scanning process, the method comprising:
holding the workpiece on a mechanical stage;
carrying out the stationary process by moving one of the workpiece on the mechanical stage in relation to a processing device, and the processing device in relation to the workpiece, under control of a stage controller;
carrying out a scanning process by scanning a beam over the workpiece while the workpiece is either stationary or moving on the mechanical stage, the scanning process comprising enslaving the stage controller to the scanner controller such that the scanner controller controls the scanning process.

11. The method of claim 10, comprising using the scanner controller to trigger the laser during the scanning process.

12. The method of claim 11, wherein the stationary process is one member of the group consisting of:
a camera taking photographs,
a laser firing shots,
a pick up process using a pick up tool,
a pick up process for picking parts,
a machining process using a tool to machine a part, and
an inspection process using an inspection tool to inspecting a surface or a bulk of the workpiece or a part of the workpiece.

13. The method of claim 10, wherein said enslaving comprises synchronizing the scanner and the scanner controller, the mechanical stage, the stage controller and a supervisor controller.

14. The method of claim 13, comprising synchronizing said stage controller to said scanner controller by obtaining a clock being used by said scanner controller and providing a derivative of said clock to said stage controller.

15. Apparatus for laser processing of relatively large workpieces, the processing comprising a stationary process and a scanning process, the apparatus comprising:
a mechanical stage configured to hold the workpiece;
a stage controller configured to operate said mechanical stage;
a scanner configured to scan a laser beam over said workpiece;
a scanner controller configured to operate said scanner, and
a controller,
wherein the stage controller is connected to receive path signals directly from said controller to operate the stationary process, the stationary process comprising moving the workpiece on said mechanical stage in relation to a stationary processing device, or moving the processing device in relation to a stationary workpiece, and wherein said scanner controller is connected to receive path signals directly from said controller to operate the scanning process by scanning a beam over the workpiece, and moving said mechanical stage via said stage controller, said stage controller being enslaved to said scanner controller during the scanning process and being independent of said scanner controller during the stationary process.
